(19) United States
(12) Patent Application Publication
(10) Pub. No.: US 2014/0258875 A1
(43) Pub. Date: Sep. 11, 2014

(54) SYSTEMS, METHODS AND MEDIA FOR PROVIDING HISTORICAL NAVIGATION CONTROLS FOR A MOBILE DEVICE USER

(71) Applicant: APPSENSE LIMITED, Warrington (GB)

(72) Inventor: Richard James SOMERFIELD, San Jose, CA (US)

(73) Assignee: APPSENSE LIMITED, Warrington (GB)

(21) Appl. No.: 13/793,508

(22) Filed: Mar. 11, 2013

(51) Int. Cl. G06F 3/0484

(52) U.S. Cl. CPC G06F 3/0484
USPC 715/738

(57) ABSTRACT

Systems, methods and media for providing multi-dimensional historical navigation controls are provided. One method includes recording, at a mobile device, a first navigation path associated with a data item accessed by a user using the mobile device and enabling a plurality of elements in the first navigation path by generating a plurality of active controls each corresponding to one of the plurality of elements. The method also includes displaying a UI control including the first navigation path that is presented using the enabled elements. The method further includes detecting a selection of one of the enabled elements of the first navigation path when the user selects the active control corresponding to the selected one of the enabled elements and navigating to the site associated with the selected one of the enabled elements by jumping to the site from a first site associated with any other one of the enabled elements.

### TECHNICAL FIELD

Disclosed systems, methods and media relate to providing a historical navigation control for a mobile device user. Specifically, disclosed systems, methods and media relate to providing a multi-dimensional historical navigation control that can enable a mobile device user to navigate from a site or location associated with one element in a navigational path to another element site/location in the same navigational path or to an element site/location in a different navigational path.

### BACKGROUND

Using a mobile device to access, update and manage data has a number of benefits. For example, the user of a mobile device can manage her data or access new information on the move. However, using a mobile device to access and manage data also has a few drawbacks. One of the most significant drawbacks has to do with navigating and managing documents and files on a relatively small display screen, thereby creating certain restrictions on user interface (UI) flows. Navigation issues are particularly prone to causing problems for mobile devices due to the nature of the operating environment of mobile devices, such as relatively limited CPU and memory capacity, limited network bandwidth (wireless resource), and limited power supply (battery power).

Existing technology provides a stack-based user interface (UI) approach in which a new UI element, such as a button showing a back arrow, is added to a stack each time a mobile device user navigates deeper into a navigational path, such as a file directory path or a browsing path. When the user wants to navigate back out the navigation path, the user presses the UI element and the UI element pops out of the stack and takes back the display screen to its immediate parent directory or immediate parent web page in the navigational path. This single-dimensional navigation approach enables the mobile device user to navigate back out from a depth of a navigation path, but it tends to waste computational, power and/or network resources. Suppose, for example, a mobile device user starts out at the CNN homepage and navigates through a few web pages, generating a browsing path such as “www.cnn.com/entertainment/movies/BoxOffice/Space Pirates.” If the user wants to revisit the CNN homepage, she will have to press the (back arrow) button four times to navigate back to the CNN home page through the three intermediate web pages—i.e., (1) “www.cnn.com/entertainment/movies/BoxOffice,” (2) “www.cnn.com/entertainment/movies,” and (3) “www.cnn.com/entertainment.” Regardless of the direction (forward, backward), each press of navigation button expends processing, memory and/or network resources and drains the battery power.

### SUMMARY

In accordance with the disclosed subject matter, systems, methods and media for providing a historical navigation control for a mobile device user are provided. Specifically, disclosed systems, methods and media provide for providing a multi-dimensional historical navigation control for enabling fast and resource efficient intra/inter-application navigations for accessing and managing data using a mobile device. For example, the disclosed subject matter includes a method that includes recording, at a mobile device, a first navigation path associated with a data item that is accessed by a user using the mobile device. The method also includes enabling, at the mobile device, a first plurality of elements included in the first navigation path by generating a first plurality of active controls each corresponding to one of the first plurality of elements regardless of whether a site associated with each of the first plurality of elements is actually accessed by the user. The method further includes displaying, at the mobile device, a user interface (UI) control including the first navigation path that is presented using the enabled first plurality of elements of the first navigation path.

The method also includes detecting, at the mobile device, a selection by the user of one of the enabled first plurality of elements of the first navigation path when the user selects the active control corresponding to the selected one of the enabled first plurality of elements, and navigating to the site associated with the selected one of the enabled first plurality of elements by jumping directly to the site from a first site associated with any other one of the enabled first plurality of elements in the first navigation path.

In some embodiments, the method may further include adding the recorded first navigation path to a list of navigation paths that is stored at the mobile device, wherein the list of navigation paths is displayed on the UI control and includes a second navigation path. In some embodiments, the method may further include providing a user interface for the user to edit the list of navigation paths, wherein editing the list of navigation paths includes modifying at least one of the first navigation path and the second navigation path. In some embodiments, the first navigation path includes a file directory path, the data item includes a document stored in the mobile device and the site includes one of a file directory or a file included in a file directory. In some embodiments, the first navigation path includes a browsing path, the data item includes a web page and the site includes one of a web site or a web page included in the web site.

In some embodiments, each of the first plurality of active controls includes one of a control button or an active link and detecting the selection by the user includes detecting a process of the control button or a click on the active link. In some embodiments, the UI control includes a second navigation path presented using a second plurality of active controls each corresponding to one of a second plurality of elements of the second navigation path and navigating to the site associated with the selected one of the first plurality of elements in the first navigation path includes jumping directly to the site from a second site associated with any of the second plurality of elements in the second navigation path. In some embodiments, the UI control is displayed in response to detecting a selection by the user of a navigate button displayed on a display screen of the mobile device.

The disclosed subject matter also includes an apparatus that includes one or more interfaces configured to provide communication with one or more devices over a network and a processor in communication with the one or more interfaces. The processor is configured to run a historical navigation module that is configured to record a first navigation path associated with a data item that is accessed by a user. The historical navigation module is also configured to enable a first plurality of elements included in the first navigation path by generating a first plurality of active controls each corresponding to one of the first plurality of elements regardless of whether a site associated with each of the first plurality of elements is actually accessed by the user. The historical navigation module is further configured to display a user interface (UI) control including the first navigation path that is presented using the enabled first plurality of elements of the first navigation path.

The historical navigation module is also configured to detect a selection by the user of one of the enabled first plurality of elements of the first navigation path when the user selects the active control corresponding to the selected one of the enabled first plurality of elements, and navigate to the site associated with the selected one of the enabled first plurality of elements by jumping directly to the site from a first site associated with any other one of the first plurality of elements in the first navigation path.

The disclosed subject matter further includes a non-transitory computer readable medium having executable instructions operable to cause an apparatus to record a first navigation path associated with a data item that is accessed by a user. The executable instructions are also operable to cause the apparatus to enable a first plurality of elements included in the first navigation path by generating a first plurality of active controls each corresponding to one of the first plurality of elements regardless of whether a site associated with each of the first plurality of elements is actually accessed by the user. The executable instructions are further operable to cause the apparatus to display a user interface (UI) control including the first navigation path that is presented using the enabled first plurality of elements of the first navigation path.

The executable instructions are also operable to cause the apparatus to detect a selection by the user of one of the enabled first plurality of elements of the first navigation path when the user selects the active control corresponding to the selected one of the enabled first plurality of elements, and navigate to the site associated with the selected one of the enabled first plurality of elements by jumping directly to the site from a first site associated with any other one of the first plurality of elements in the first navigation path.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 illustrates a diagram of a multi-dimensional navigation control in accordance with an embodiment of the disclosed subject matter.

FIG. 3 is a flow diagram for providing historical navigation controls in accordance with an embodiment of the disclosed subject matter.

FIG. 4 is a block diagram of a computing device in accordance with an embodiment of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems, methods and media that are within the scope of the disclosed subject matter.

The disclosed systems, methods and media are provided for providing a multi-dimensional historical navigation control for enabling fast and resource efficient intra/inter-application navigations for accessing and managing data using a mobile device. In one embodiment, for example, a user of a mobile device searches for a particular document (e.g., “BalanceSheet.txt”) that she created a few months ago. It has been some time since the user last viewed the document and thus she is not certain of the location of the document. The user searches the directory tree stored in her mobile device by visiting several document directories before locating the document in a document folder (e.g., “Documents/Personal/Expenses/2012/October/”). While the user is reviewing and updating the document, the user receives on her mobile device a tweet regarding an upcoming snowstorm. The tweet includes a link to a news article about the storm that is provided by CNN (e.g., “http://www.cnn.com/news/articles/SnowStorm.html”). The user chooses to read the tweet and clicks on the link to view the news article.

After reading the article, she opens a messenger application to send a text message to her aunt to alert her about the fast approaching snowstorm. After sending the text message, she wants to go back to updating the document (e.g., “BalanceSheet.txt”). She clicks a control button labeled “Back” displayed on the top of the mobile device screen. In response, a user interface (UI) control pops up, displaying active controls, such as active links or buttons, for elements of navigation path(s) associated with each application program she used. For example, the UI pop-up control may display each element in the directory path (e.g., “Documents,” “Personal,” “Expenses,” “2012” and “October”) and in the browsing path (“www.cnn.com,” “news,” “articles,” and “SnowStorm.html”) as an active link. When the UI control pops up, the user may click on the directory path element, “BalanceSheet.txt,” to go back to updating the document. The user can also click on the directory element, “Personal,” to view the documents stored in the “Documents/Personal” directory without having to traverse back to that directory by clicking through each of the intermediate directories (e.g., “Expense,” “2012,” and “October” directories).

Before going back to update the document, the user can first click on the browsing path element, “news,” to read or view other available CNN news articles and/or video clips. Accordingly, the user is enabled to more quickly navigate from a current web page to any web page associated with an element included in the same browsing path regardless of whether she has previously visited the web page.

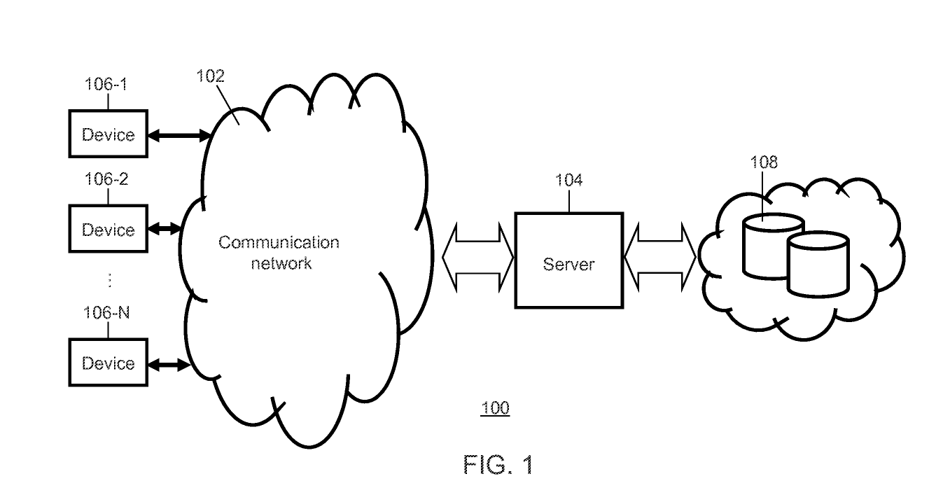

FIG. 1 illustrates a diagram of a networked communication arrangement 100 in accordance with an embodiment of the disclosed subject matter. The networked communication arrangement 100 can include a communication network 102, a server 104, at least one computing device 106 (e.g., computing devices 106-1, 106-2, . . . 106-N), and a database 108.

Each computing device 106 can send data to, and receive data from, the server 104 over the communication network 102. Each computing device 106 can be directly coupled to the server 104; alternatively, each computing device 106 can be connected to the server 104 via any other suitable device(s), communication network(s), or combination thereof. For example, each computing device 106 can be coupled to the server 104 via one or more routers, switches, access points, and/or communication networks (as described below in connection with communication network 102). A computing device 106 can include a mobile computer, a tablet computer, a cellular device, a smartphone or any mobile computing system that is capable of performing computation. The server 104 can be a single server, such as a network (management) server, a database server, a file server, an application server, or a farm of servers in a data center.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above.

The server 104 can be coupled to a database system. The database 108 can include at least one of two types of databases: a local database and a remotely located database. The database 108 can include any data supported by one or more data structures; alternatively, it could include one or more database management system (DBMS) or a distributed database. The database 108 can also include at least one of a relational database, object database (a.k.a., object-oriented database), XML database, cloud database, active database, and a data warehouse. The database 108 may include at least one physical, non-transitory storage medium.

In some embodiments, the database 108 can be provided as an enterprise system in a corporate environment For example, the communication network 102, the (proxy) server 104, the computing devices 106, and the database 108 can be located in close proximity and can be a part of a single company. In some cases, the (proxy) server 104, the computing devices 106, and the database 108 can be located in the same building and can be coupled to one another via a local communication network. The local communication network can include a local area network (LAN), a corporate network, and a virtual private network (VPN) associated with the corporate network. FIG. 1 shows the database 108 as separate from the communication network 102. However, the database 108 can be part of communication network 102 or another communication network.

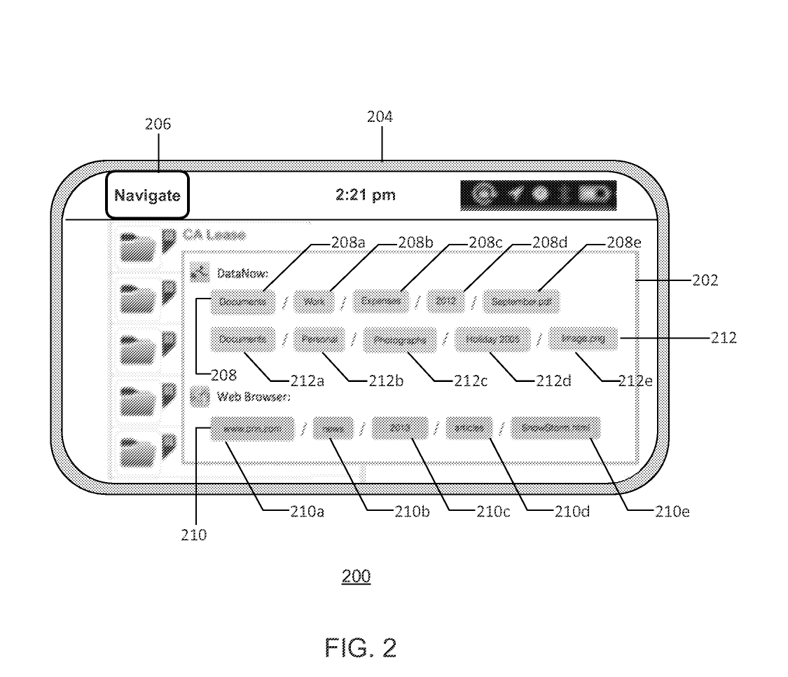

FIG. 2 illustrates a diagram 200 of a multi-dimensional navigation control 202 in accordance with an embodiment of the disclosed subject matter. The navigation control 202 pops up when a user of a mobile device 204 activates a navigate button 206. In some embodiments, the user can activate the navigate button 206 by depressing the button for a predetermined amount of time (i.e., long-pressing). The multi-dimensional navigation control 202 may include one or more navigation paths, such as file directory paths 208, 212 and/or a browsing path 210, and each navigation path can be associated with a particular application program or a combination of application programs. For example, the file directory paths 208, 212 can be associated with a directory management program and the browsing path 210 can be associated with a web browser. The navigation control 202 can display navigation paths in any suitable manner. In some embodiments, for example, more than one navigation path can be displayed on the screen at the same time. In some embodiments, one navigation control can be displayed on the screen at a time.

Each navigation path included in the multi-dimensional navigation control 202 in turn includes a plurality of navigation path elements, each of which is enabled to be activated by a user. For example, the file directory path 208 represents a directory path, “Documents/Work/Expenses/2012/,” for a document “September.pdf” and includes five (5) directory path elements, “Documents,” “Work,” “Expenses,” “2012,” and “September.pdf.” Each of the five directory path elements is enabled such that, when selected (e.g., pressed/clicked) by the user, each path element can navigate to the directory associated with the activated path element.

For example, the file directory path 208 includes five control buttons 208a-208e and each control button is associated with an individual directory in the directory path 208. For instance, the control button 208a is associated with the “Documents” directory and the control button 208c is associated with the “Expenses” directory. When the user selects the control button 208b, the user can navigate back to the “Work” directory (i.e., “/Documents/Work/”) directly from, e.g., the “2012” directory (i.e., “/Documents/Work/Expenses/2012/”). Likewise, the file directory path 212 includes five control buttons 212a-212e and each control button is associated with an individual directory in the directory path 212. In some embodiments, navigation path elements are enabled using an active link similar to a hypertext link.

Similarly, browsing path 210 represents a link, “www.cnn.com/news/2013/articles/,” for a web page “SnowStorm.html” and includes five (5) browsing path elements, “www.cnn.com,” “news,” “2013,” “articles,” and “SnowStorm.html.” Each of the five browsing path elements is also enabled such that each path element, when selected by the user, can enable the user to navigate to the web page associated with the activated path element. For example, the browsing path 210 includes five control buttons 210a-210e and each control button is associated with an individual web page in the browsing path 210. For instance, the control button 210a is associated with the CNN home page, “www.cnn.com” and the control button 210c is associated with the web page having an address, or a universal resource locator (URL), “www.cnn.com/news/2013.” When the user selects the control button 210a, for instance, the user can navigate back to the CNN home page (“www.cnn.com”) directly from, e.g., the web page including “SnowStorm.html” article (“www.cnn.com/news/2013/articles/SnowStorm.html”).

For illustration purposes, FIG. 2 shows three navigation paths, each of which has five control buttons. However, any suitable number of navigation paths with any suitable number of control buttons can be provided.

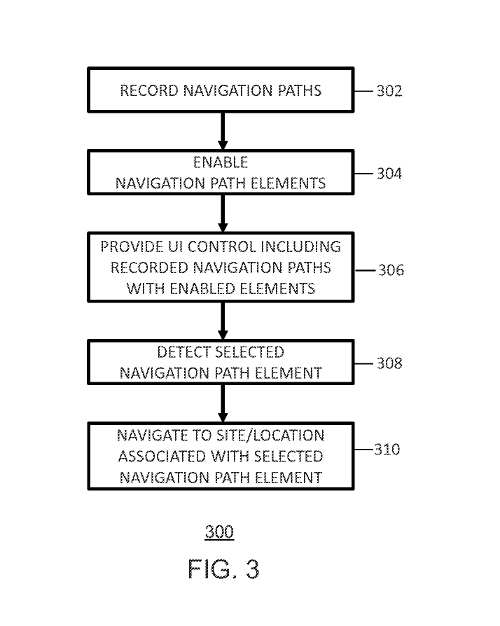

FIG. 3 is a flow diagram 300 for providing a multi-dimensional historical navigation control in accordance with an embodiment of the disclosed subject matter. At 302, a navigation path associated with a data item that is viewed or updated by a user using her mobile device is recorded. Referring back to FIG. 2, for example, if the user locates and updates the document “September.pdf,” the directory path 208 associated with the document (i.e., “/Documents/Work/Expenses/2012/September.pdf”) is recorded. Similarly, if the user visits the web site including the news article “SnowStorm.html,” the browsing path 210 associated with the news article is recorded. A directory path or a browsing path (also referred to as a URL link) is recorded regardless of whether the user actually navigated through the directory path or the URL link. For example, the directory path 208 is recorded regardless of whether the user walked through each of the intermediate directories (e.g., “Documents,” “Work,” “Expenses,” “2012”) to access the document. For instance, the directory path 208 is recorded if the user located the document, “September.pdf,” from a direct link sent to the user via an email for accessing the document.

At 304, each path element included in the recorded navigational path is enabled. Referring back to FIG. 2, for example, suppose that the user of mobile device 204 receives an email including a hypertext link to the web page for the news article “SnowStorm.html” and clicks the link to read the article. After the browsing path 210 of the article (i.e., “www.cnn.com/news/2013/articles/SnowStorm.html”) is recorded, each element in the browsing path 210 is enabled by creating an active control, such as a control button or an active link that when activated, enables the user to navigate to the web page associated with the element. For instance, the control buttons 210a-210e are created, respectively, for the CNN home page (“www.cnn.com”), the web page for the “news” element (“www.cnn.com/news”), the web page for the “2013” element (“www.cnn.com/news/2013”), the web page for the “articles” element (“www.cnn.com/news/2013/articles”) and the web page for the “SnowStorm.html” element (“www.cnn.com/news/2013/articles/SnowStorm.html”).

At 306, a user interface (UI) control is provided for displaying one or more recorded navigational paths that each includes a set of enabled path elements. As discussed earlier in reference to FIG. 2, for example, when a user of the mobile device 204 wants to navigate out of the current display content (e.g., a document or a web page), the user presses the navigate button 206 to explore multi-dimensional historical navigation options that may be available for her. For example, after visiting a web page including an article about a fast approaching weather condition (SnowStorm.html), the user may wish to go back to a document (September.pdf) which she was updating before she navigated to the web page. In such a case, the user can press the navigate button 206. In response to the user's activation of the navigate button 206, the multi-dimensional navigation control 202 pops up. The multi-dimensional navigation control 202 displays each recorded navigation path (i.e., directory paths 208, 212 and browsing path 210). The navigation control 202 also displays control buttons (i.e., 208a-208e, 210a-210e, 212a-212e) for the associated navigation path elements (i.e., “Documents,” “Work,” “Personal,” “Expenses,” “Photographs,” “2012,” “Holiday 2005,” “September.pdf,” “Image.png,” “www.cnn.com,” “news,” “2013,” “articles,” and “SnowStorm.html”). Each control button, when selected (e.g., pressed) by the user, enable the user to navigate to the site or location that is associated with the selected navigation path element.

At 308, a selection by the user of a navigation path element is detected. Referring back to FIG. 2, for example, a selection by a user of the mobile device 204 of an element from the directory path 208, 210 or the browsing path 210 is detected when the user presses a control button associated with the selected path element. For instance, a selection by the user of the directory element “Holiday 2005” is detected when the user presses the control button 212d.

At 310, the selection by the user of a navigation path element enables the user to navigate to a site (e.g., web site) or a location (e.g., file directory) associated with the selected navigation path element regardless of whether the selected path element was actually visited by the user before. Referring to FIG. 2, for example, when a user of the mobile device 204 selects the browsing path element “www.cnn.com,” the selection enables the user to navigate to the CNN home page regardless of the current display context. For instance, the user could navigate to the CNN home page from the “2012” directory, the “Work” directory, the “article” web page, or from any other directory or web page included in any of the directory paths 208, 212 and the browsing path 210.

Thereby, the user of the mobile device 204 can jump from one part of a navigation path structure directly to another part of the same or a different navigation path structure without having to navigate through multiple intermediate path elements between source and target parts of the path structure(s). This reduction in the number of separate navigations in turn is translated to a reduction in wasted CPU cycles, wasted memory resources, wasted battery power and/or wasted wireless network resource as well as a reduction in wasted time for the user.

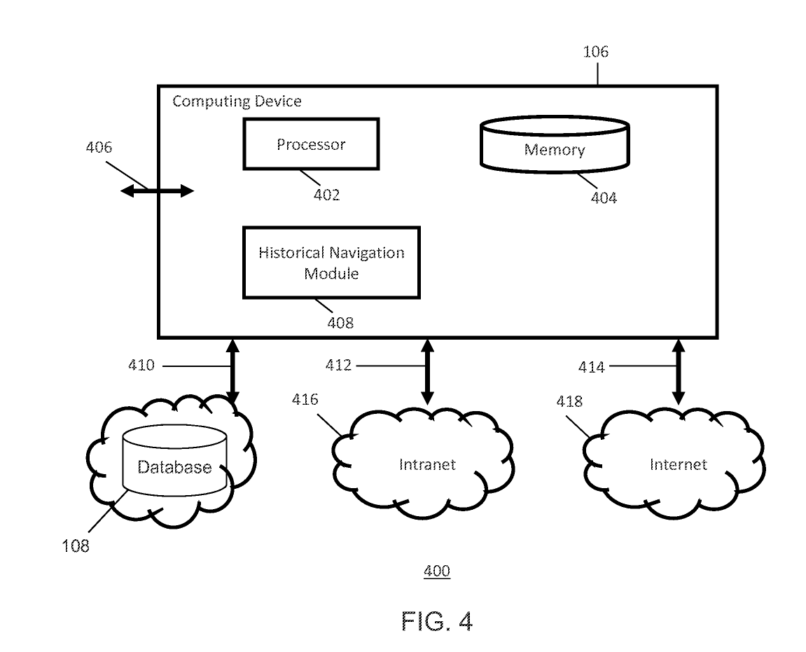

FIG. 4 is a block diagram 400 of a computing device 106 in accordance with certain embodiments of the disclosed subject matter. The block diagram 400 shows a computing device 106, which includes a processor 402, a memory 404, interfaces 406, 410, 412, and 414, a historical navigation module 408, a database 108, an Intranet 416, and the Internet 418. The memory 404 and the interfaces 406, 410, 412, and 414 are communicatively coupled to the processor 402. The computing device 106 can communicate with the server 104 (not shown) via the interface 406; the computing device 106 can communicate with the database 108 via the interface 410; the computing device 106 can communicate with the Intranet 416 via the interface 412; and the computing device 106 can communicate with the Internet 418 via the interface 414. The interfaces 406, 410, 412, and 414 are shown as separate interfaces but may be the same physical interface. The processor 402 can run software programs and modules, including the historical navigation module 408. The memory 404 is capable of storing data that can be used by the processor 402 to run the software programs and modules, including the historical navigation module 408.

The historical navigation module 408 can be configured to communicate, or interact, with server 104 through the interface 406 for recording a first navigation path associated with a data item that is accessed by a user and enabling each element included in the first navigation path, regardless of whether a site associated with the element is actually accessed by the user, by generating an active control for the element. The historical navigation module 408 can be also configured for displaying a user interface (UI) control including the first navigation path that is presented using the enabled elements of the first navigation path. The historical navigation module 408 can be further configured for detecting a selection by the user of an element of the first navigation path when the user selects the active control associated with the selected element by activating the active control and navigating to a site associated with the selected element by jumping directly to the site from a site associated with any other element in the first navigation path.

The historical navigation module 408 can be configured for adding the recorded first navigation path to a list of navigation paths that is stored at the apparatus and wherein the list of navigation paths is displayed on the UI control and includes a second navigation path. The historical navigation module 408 can be configured for providing a user interface for the user to edit the list of navigation paths and wherein editing the list of navigation paths includes modifying at least one of the first navigation path and the second navigation path.

The computing device 106 having the historical navigation module 408 can perform the above-described operations in accordance with certain embodiments of the disclosed subject matter. The computing device 106 may include additional modules, less modules, or any other suitable combination of modules that perform any suitable operation or combination of operations.

The interfaces 406, 410, 412, and 414 provide an input and/or output mechanism to communicate over a network. The interfaces 406, 410, 412, and 414 enable the computing device 106 to communicate with the server 104, as well as other network nodes in the communication network 102. The interfaces 406, 410, 412, and 414 can be implemented in hardware to send and receive signals in a variety of mediums, such as optical, copper, and wireless, and in a number of different protocols some of which may be non-transient.

The computing device 106 can include user equipment (also referred to as mobile device, mobile terminal, etc.). The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device 106 also includes any mobile platforms capable of computations and communication. Non-limiting examples can include mobile set-top units, portable digital video recorders (DVR), mobile computers, netbooks, laptops, and any other audio/visual equipment with mobile computation capabilities. The computing device 106 may be configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The computing device 106 can also provide a variety of user interfaces such as a keyboard, a touch screen, a trackball, a touch pad, and/or a mouse. The computing device 106 may also include speakers and a display device in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, systems and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
recording, at a mobile device, a first navigation path associated with a data item that is accessed by a user using the mobile device;
enabling, at the mobile device, a first plurality of elements included in the first navigation path by generating a first plurality of active controls each corresponding to one of the first plurality of elements regardless of whether a site associated with each of the first plurality of elements is actually accessed by the user;
displaying, at the mobile device, a user interface (UI) control including the first navigation path that is presented using the enabled first plurality of elements of the first navigation path;
detecting, at the mobile device, a selection by the user of one of the enabled first plurality of elements of the first navigation path when the user selects the active control corresponding to the selected one of the enabled first plurality of elements; and
navigating to the site associated with the selected one of the enabled first plurality of elements by jumping directly to the site from a first site associated with any other one of the enabled first plurality of elements in the first navigation path.

2. The method of claim 1, further comprising adding the recorded first navigation path to a list of navigation paths that is stored at the mobile device, wherein the list of navigation paths is displayed on the UI control and includes a second navigation path.

3. The method of claim 2, further comprising providing a user interface for the user to edit the list of navigation paths, wherein editing the list of navigation paths includes modifying at least one of the first navigation path and the second navigation path.

4. The method of claim 1, wherein the first navigation path includes a file directory path, the data item includes a document stored in the mobile device and the site includes one of a file directory or a file included in a file directory.

5. The method of claim 1, wherein the first navigation path includes a browsing path, the data item includes a web page and the site includes one of a web site or a web page included in the web site.

6. The method of claim 1, wherein each of the first plurality of active controls includes one of a control button or an active link and wherein detecting the selection by the user includes detecting a press of the control button or a click on the active link.

7. The method of claim 1, wherein the UI control includes a second navigation path presented using a second plurality of active controls each corresponding to one of a second plurality of elements of the second navigation path and wherein navigating to the site associated with the selected one of the first plurality of elements in the first navigation path includes jumping directly to the site from a second site associated with any of the second plurality of elements in the second navigation path.

8. The method of claim 1, wherein the UI control is displayed in response to detecting a selection by the user of a navigate button displayed on a display screen of the mobile device.

9. An apparatus comprising:
one or more interfaces configured to provide communication with one or more devices over a network; and
a processor, in communication with the one or more interfaces, configured to run a historical navigation module stored in memory that is configured to:
record a first navigation path associated with a data item that is accessed by a user;
enable a first plurality of elements included in the first navigation path by generating a first plurality of active controls each corresponding to one of the first plurality of elements regardless of whether a site associated with each of the first plurality of elements is actually accessed by the user;
display a user interface (UI) control including the first navigation path that is presented using the enabled first plurality of elements of the first navigation path;
detect a selection by the user of one of the enabled first plurality of elements of the first navigation path when the user selects the active control corresponding to the selected one of the enabled first plurality of elements; and
navigate to the site associated with the selected one of the enabled first plurality of elements by jumping directly to the site from a first site associated with any other one of the first plurality of elements in the first navigation path.

10. The apparatus of claim 9, wherein the historical navigation module is further configured to add the recorded first navigation path to a list of navigation paths that is stored at the apparatus and wherein the list of navigation paths is displayed on the UI control and includes a second navigation path.

11. The apparatus of claim 10, wherein the historical navigation module is further configured to provide a user interface for the user to edit the list of navigation paths and wherein editing the list of navigation paths includes modifying at least one of the first navigation path and the second navigation path.

12. The apparatus of claim 9, wherein the first navigation path includes a file directory path, the data item includes a document stored in the apparatus and the site includes one of a file directory or a file included in a file directory.

13. The apparatus of claim 9, wherein the first navigation path includes a browsing path, the data item includes a web page and the site includes one of a web site or a web page included in the web site.

14. The apparatus of claim 9, wherein the UI control includes a second navigation path presented using a second plurality of active controls each corresponding to one of a second plurality of elements of the second navigation path and wherein the historical navigation module is further configured to navigate to the site associated with the selected one of the first plurality of elements in the first navigation path by jumping directly to the site from a second site associated with any of the second plurality of elements in the second navigation path.

15. A non-transitory computer readable medium having executable instructions operable to cause an apparatus to:
record a first navigation path associated with a data item that is accessed by a user;
enable a first plurality of elements included in the first navigation path by generating a first plurality of active controls each corresponding to one of the first plurality of elements regardless of whether a site associated with each of the first plurality of elements is actually accessed by the user;
display a user interface (UI) control including the first navigation path that is presented using the enabled first plurality of elements of the first navigation path;
detect a selection by the user of one of the enabled first plurality of elements of the first navigation path when the user selects the active control corresponding to the selected one of the enabled first plurality of elements; and
navigate to the site associated with the selected one of the enabled first plurality of elements by jumping directly to the site from a first site associated with any other one of the first plurality of elements in the first navigation path.

16. The computer readable medium of claim 15, wherein the executable instructions are further operable to cause the apparatus to add the recorded first navigation path to a list of navigation paths that is stored at the apparatus and wherein the list of navigation paths is displayed on the UI control and includes a second navigation path.

17. The computer readable medium of claim 16, wherein the executable instructions are further operable to cause the apparatus to provide a user interface for the user to edit the list of navigation paths and wherein editing the list of navigation paths includes modifying at least one of the first navigation path and the second navigation path.

18. The computer readable medium of claim 15, wherein the first navigation path includes a file directory path, the data item includes a document stored in the apparatus and the site includes one of a file directory or a file included in a file directory.

19. The computer readable medium of claim 15, wherein the first navigation path includes a browsing path, the data item includes a web page and the site includes one of a web site or a web page included in the web site.

20. The computer readable medium of claim 15, wherein the UI control includes a second navigation path presented using a second plurality of active controls each corresponding to one of a second plurality of elements of the second navigation path and wherein the executable instructions are further operable to cause the apparatus to navigate to the site associated with the selected one of the first plurality of elements in the first navigation path by jumping directly to the site from a second site associated with any of the second plurality of elements in the second navigation path.
